(19) United States
(12) Patent Application Publication
(10) Pub. No.: US 2016/0119695 A1
(43) Pub. Date: Apr. 28, 2016

(54) METHOD, APPARATUS, AND SYSTEM FOR SENDING AND PLAYING MULTIMEDIA INFORMATION

(71) Applicant: Tencent Technology (Shenzhen) Company Limited, Shenzhen (CN)

(72) Inventors: Jun GUO, Shenzhen (CN); Shenglong LING, Shenzhen (CN); Yong HU, Shenzhen (CN); Chaojian ZHOU, Shenzhen (CN)

(21) Appl. No.: 14/986,821

(22) Filed: Jan. 4, 2016

Related U.S. Application Data
(63) Continuation of application No. PCT/CN2015/073906, filed on Mar. 9, 2015.

(30) Foreign Application Priority Data
Mar. 12, 2014 (CN) 201410090424.1

(51) Int. Cl. H04N 21/858; H04N 21/81; H04N 21/8352; H04N 21/2547; H04N 21/654; H04N 7/173; H04N 21/472

(52) U.S. Cl. CPC H04N 21/858; H04N 7/17318; H04N 21/812; H04N 21/47202; H04N 21/2547; H04N 21/654; H04N 21/8352

(57) ABSTRACT

A method, an apparatus, and a system for sending and playing multimedia information relate to the field of computers. The method includes: receiving a multimedia playback request sent by a terminal; acquiring a resource value corresponding to each playback mode for playing multimedia information; selecting a playback mode with a maximum resource value; and acquiring an identifier of the multimedia information according to the selected playback mode, and sending the selected playback mode and the acquired identifier of the multimedia information to the terminal. The apparatus includes: a first receiving module, a first acquisition module, a selection module, a second acquisition module, and a first sending module. The system includes: a third-party platform and a terminal.

### CROSS REFERENCE TO RELATED APPLICATION

This application is claims the benefit and priority of International Application No. PCT/CN2015/073906, filed on Mar. 9, 2015, which claims priority to Chinese Application No. 201410090424.1, filed Mar. 12, 2014. The entire disclosures of each of the above applications are incorporated herein by reference.

### FIELD OF THE TECHNOLOGY

This application relates to the field of computers, and in particular, to a method, an apparatus, and a system for sending and playing multimedia information.

### BACKGROUND OF THE DISCLOSURE

At present, before a video player plays a video requested by a user, a third-party platform often sends a piece of multimedia information to the video player, where the multimedia information may be a picture, a video, an advertisement, or the like. The video player first plays the multimedia information, and plays, only after completely playing the multimedia information, the video requested by the user.

In the existing technology, a method for sending multimedia information is provided, and may be that: a terminal sends a multimedia playback request to a third-party platform; the third-party platform receives the multimedia playback request, acquires position information of the terminal, and sends a recommendation request to multiple resource servers, where the recommendation request carries the position information of the terminal; for each resource server, the resource server acquires a resource value according to the position information of the terminal, and sends an identifier of multimedia information and the resource value to the third-party platform; the third-party platform acquires a maximum resource value from resource values sent by the resource servers, and acquires an identifier of multimedia information that is sent by a resource server corresponding to the maximum resource value, and sends the multimedia information corresponding to the acquired identifier of the multimedia information to the terminal; and the terminal plays the multimedia information.

### SUMMARY

According to one aspect, an embodiment of this application provides a method for sending multimedia information, including:

receiving a multimedia playback request sent by a terminal;

acquiring a resource value corresponding to each playback mode for playing multimedia information;

selecting a playback mode with a maximum resource value; and

acquiring an identifier of the multimedia information according to the selected playback mode, and sending the selected playback mode and the acquired identifier of the multimedia information to the terminal.

According to another aspect, an embodiment of this application provides a method for playing multimedia information, including:

sending a multimedia playback request to a third-party platform, so that the third-party platform selects a playback mode with a maximum resource value and acquires an identifier of multimedia information;

receiving the selected playback mode and the acquired identifier of the multimedia information that are sent by the third-party platform;

acquiring the corresponding multimedia information according to the acquired identifier of the multimedia information; and

playing the acquired multimedia information according to the selected playback mode.

According to still another aspect, an embodiment of this application provides an apparatus for sending multimedia information, including:

a first receiving module, configured to receive a multimedia playback request sent by a terminal;

a first acquisition module, configured to acquire a resource value corresponding to each playback mode for playing multimedia information;

a selection module, configured to select a playback mode with a maximum resource value;

a second acquisition module, configured to acquire an identifier of the multimedia information according to the selected playback mode; and

a first sending module, configured to send the selected playback mode and the acquired identifier of the multimedia information to the terminal.

### BRIEF DESCRIPTION OF THE DRAWINGS

To describe the technical solutions in the embodiments of this application more clearly, the following briefly introduces the accompanying drawings required for describing the embodiments. Apparently, the accompanying drawings in the following description show merely some embodiments of this application, and a person of ordinary skill in the art may still derive other drawings from these accompanying drawings without creative efforts.

FIG. 1 is a network architecture of an application of sending and playing multimedia information according to an embodiment of this application;

FIG. 2 is a flowchart of a method for sending multimedia information according to an embodiment of this application;

FIG. 3 is a flowchart of a method for playing multimedia information according to an embodiment of this application;

FIG. 4 is a flowchart of a method for sending and playing multimedia information according to an embodiment of this application;

FIG. 5 is a schematic structural diagram of an apparatus for sending multimedia information according to an embodiment of this application;

FIG. 6 is a schematic structural diagram of an apparatus for playing multimedia information according to an embodiment of this application;

FIG. 7 is a schematic structural diagram of a third-party platform according to an embodiment of this application;

FIG. 8 is a schematic structural diagram of a terminal according to an embodiment of this application; and

FIG. 9 is a schematic structural diagram of a system for sending and playing multimedia information according to an embodiment of this application.

### DESCRIPTION OF EMBODIMENTS

To make the objectives, technical solutions, and advantages of this application clearer, the following further describes the embodiments of this application in detail with reference to the accompanying drawings.

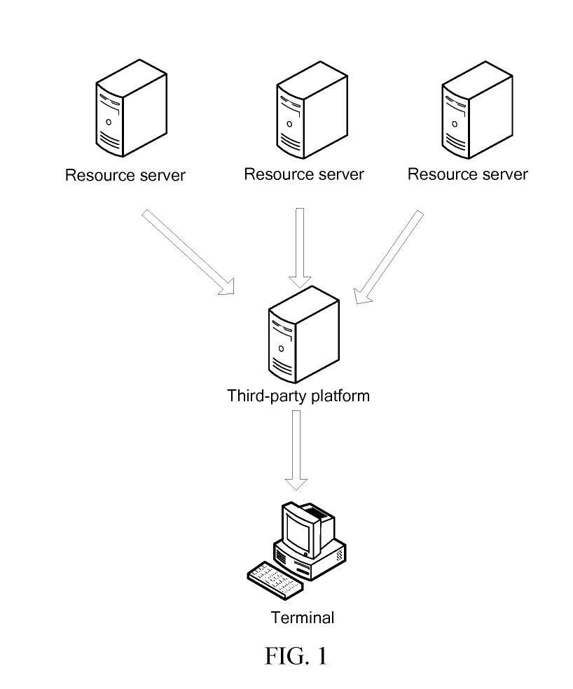

FIG. 1 shows a network architecture of an application according to an embodiment of this application. The network architecture includes a terminal, a third-party platform, and at least one resource server. The terminal sends a multimedia playback request to the third-party platform, and the third-party platform informs each resource server of each playback mode for playing multimedia information. The playback mode includes a first playback mode and a second playback mode, where the first playback mode is to serially play multimedia information by using one playback area, and the second playback mode is to play multiple pieces of multimedia information in parallel by using multiple playback areas. Each resource server selects a playback mode and sets a corresponding value for the selected playback mode. The third-party platform acquires, according to the playback mode selected by each resource server and the value set for the selected playback mode, a resource value corresponding to each playback mode, and selects a playback mode with a maximum resource value. Then the terminal plays the multimedia information according to the selected playback mode.

Embodiments of this application may be applied to the field of auction advertisements or the like. The field of auction advertisements is used as an example to describe the embodiments of this application, but does not limit the protection scope of this application. In the field of auction advertisements, the multimedia information is an advertisement, the value set for each playback mode by the resource server is an auction price of the advertisement, and the resource value corresponding to each playback mode is a profit corresponding to the playback mode. The terminal sends the multimedia playback request to the third-party platform, and the third-party platform informs each resource server of each playback mode for playing multimedia information. Each resource server selects a playback mode and sets a corresponding auction price for the selected playback mode. The third-party platform acquires, according to the playback mode selected by each resource server and the auction price corresponding to the selected playback mode, a profit corresponding to each playback mode, and selects a playback mode with a maximum profit. Then the terminal plays the advertisement according to the selected playback mode.

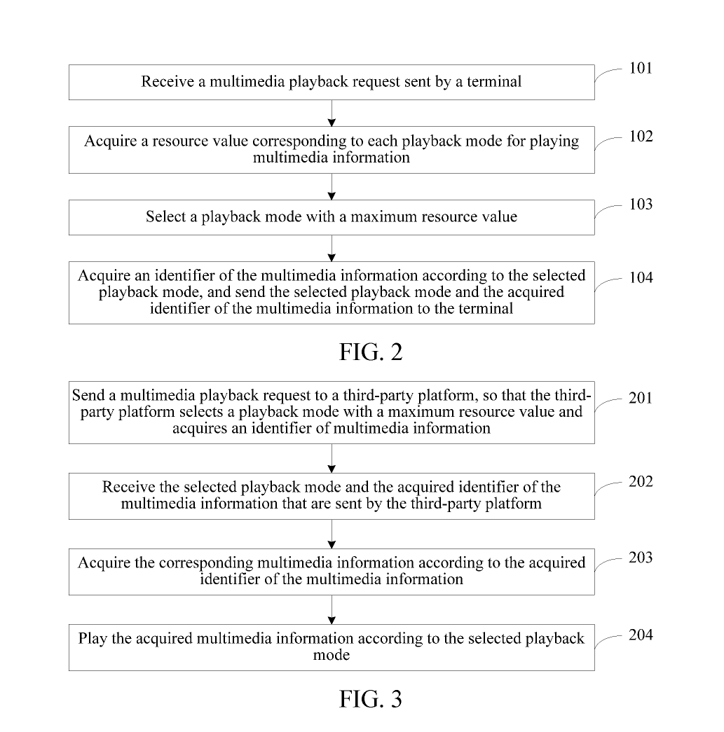

An embodiment of this application provides a method for sending multimedia information. Referring to FIG. 2, the method includes:

Step 101: Receive a multimedia playback request sent by a terminal.

Step 102: Acquire a resource value corresponding to each playback mode for playing multimedia information.

Step 103: Select a playback mode with a maximum resource value.

Step 104: Acquire an identifier of the multimedia information according to the selected playback mode, and send the selected playback mode and the acquired identifier of the multimedia information to the terminal.

In this embodiment of this application, a terminal has multiple playback modes for playing multimedia information, so that a third-party platform can send the multimedia information according to multiple modes; and the third-party platform selects a playback mode with a maximum resource value according to a resource value corresponding to each playback mode, acquires an identifier of the multimedia information according to the selected playback mode, and sends the selected playback mode and the acquired identifier of the multimedia information to the terminal, so that the third-party platform can acquire the resource value to the greatest extent.

An embodiment of this application provides a method for playing multimedia information. Referring to FIG. 3, the method includes:

Step 201: Send a multimedia playback request to a third-party platform, so that the third-party platform selects a playback mode with a maximum resource value and acquires an identifier of multimedia information.

Step 202: Receive the selected playback mode and the acquired identifier of the multimedia information that are sent by the third-party platform.

Step 203: Acquire the corresponding multimedia information according to the acquired identifier of the multimedia information.

Step 204: Play the acquired multimedia information according to the selected playback mode.

In this embodiment of this application, a terminal has multiple playback modes for playing multimedia information, so that a third-party platform can send the multimedia information according to multiple modes; and the third-party platform selects a playback mode with a maximum resource value according to a resource value corresponding to each playback mode, acquires an identifier of the multimedia information according to the selected playback mode, and sends the selected playback mode and the acquired identifier of the multimedia information to the terminal, so that the third-party platform can acquire the resource value to the greatest extent.

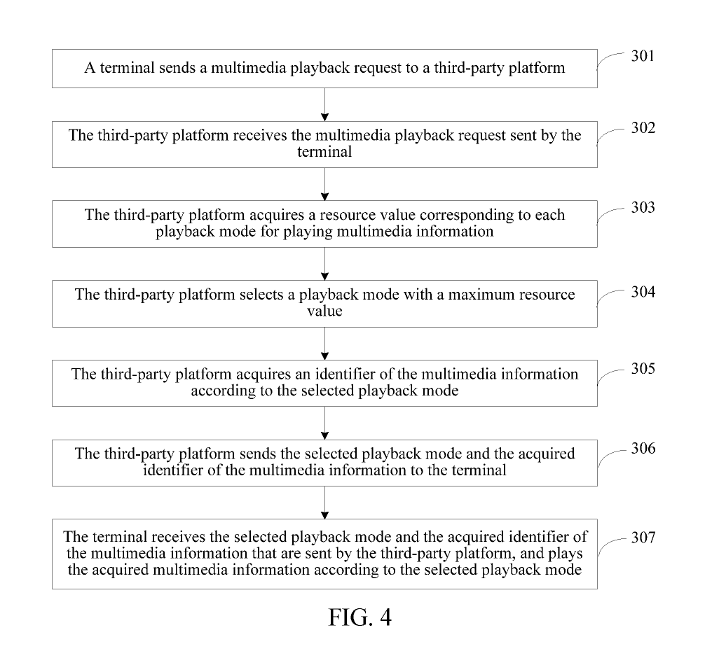

An embodiment of this application provides a procedure of sending and playing multimedia information. Before a video player plays a video requested by a first user, a third-party platform acquires a playback mode for playing multimedia information and the multimedia information, plays the acquired multimedia information according to the acquired playback mode, and plays, only after completely playing the multimedia information, the video requested by the first user. Referring to FIG. 4, the method includes:

Step 301: A terminal sends a multimedia playback request to a third-party platform.

Before the terminal plays the video requested by the first user, the terminal sends the multimedia playback request to the third-party platform, where the multimedia playback request carries position information of the terminal.

The multimedia information may be a picture, a video, an advertisement, or the like; and the terminal may be any terminal, for example, the terminal is a mobile phone terminal, a personal computer (PC) terminal, or the like. The third-party platform is any server for recommending multimedia information.

Step 302: The third-party platform receives the multimedia playback request sent by the terminal.

Specifically, the third-party platform receives the multimedia playback request sent by the terminal, and acquires the position information of the terminal according to the multimedia playback request.

Step 303: The third-party platform acquires a resource value corresponding to each playback mode for playing multimedia information.

Step 303 may be implemented by using a first mode or a second mode below. For the first mode, step (1) to step (4) below are included:

(1) The third-party platform sends a recommendation request message to each resource server in a set of resource servers, where the recommendation request message carries each playback mode for playing multimedia information and the position information of the terminal.

Specifically, the third-party platform acquires a stored identifier of each resource server in the set of resource servers, and acquires each playback mode for playing multimedia information; and the third-party platform sends the recommendation request message to each resource server in the set of resource servers according to the identifier of each resource server, where the recommendation request message carries each playback mode for playing multimedia information and the position information of the terminal.

The playback mode includes a first playback mode and a second playback mode, where the first playback mode is to serially play multimedia information by using one playback area, and the second playback mode is to play multiple pieces of multimedia information in parallel by using multiple playback areas.

The third-party platform stores the identifier of each resource server in advance, which may specifically be that:

the resource server sends a registration request message to the third-party platform, where the registration request message carries the identifier of the resource server; and the third-party platform receives the registration request message sent by the resource server, and stores the identifier of the resource server in the set of resource servers.

For example, it is assumed that the set of resource servers includes a resource server 1, a resource server 2, a resource server 3, a resource server 4, a resource server 5, and a resource server 6. The third-party platform sends the recommendation request message to the resource server 1, the resource server 2, the resource server 3, the resource server 4, the resource server 5, and the resource server 6, where the recommendation request message carries the first playback mode, the second playback mode, and the position information of the terminal.

(2) Each resource server receives the recommendation request message sent by the third-party platform, selects a playback mode according to the recommendation request message, and acquires a value corresponding to the selected playback mode, and sends a recommendation response message to the third-party platform, where the recommendation response message carries the value corresponding to the playback mode selected by the resource server.

Specifically, each resource server receives the recommendation request message sent by the third-party platform, acquires each playback mode and the position information of the terminal according to the recommendation request message, and displays each playback mode and the position information of the terminal to a second user; the second user selects a playback mode according to the position information of the terminal, and inputs a value corresponding to the selected playback mode to the resource server; and the resource server sends a recommendation response message to the third-party platform according to the value input by the second user and corresponding to the selected playback mode, where the recommendation response message carries the value corresponding to the playback mode selected by the resource server.

It should be noted that, each resource server may select one playback mode, and each resource server may also select multiple playback modes. If the resource server selects one playback mode, a value corresponding to the selected playback mode is carried in a recommendation response message sent by the resource server; and if the resource server selects multiple playback modes, a value corresponding to each selected playback mode is carried in the recommendation response message sent by the resource server.

For example, the resource server 1 is used as an example for detailed description. The resource server 1 receives the recommendation request message sent by the third-party platform, and displays the first playback mode, the second playback mode, and the position information of the terminal to a second user 1 corresponding to the resource server 1. A playback mode selected by the second user 1 according to the position information of the terminal is the first playback mode, and a value 8 corresponding to the first playback mode is input to the resource server 1. The resource server 1 sends a recommendation response message to the third-party platform, where the recommendation response message carries the first playback mode selected by the resource server 1 and the value 8 corresponding to the first playback mode. The resource server 2, the resource server 3, the resource server 4, and the resource server 5 send recommendation response messages to the third-party platform according to the foregoing process. For example, the first playback mode and a value 6 corresponding to the first playback mode are carried in a recommendation response message sent by the resource server 2; the second playback mode and a value 2 corresponding to the second playback mode are carried in a recommendation response message sent by the resource server 3; the first playback mode, the value 8 corresponding to the first playback mode, the second playback mode, and a value 3 corresponding to the second playback mode are carried in a recommendation response message sent by the resource server 4; the second playback mode and the value 3 corresponding to the second playback mode are carried in a recommendation response message sent by the resource server 5; and the second playback mode and a value 4 corresponding to the second playback mode are carried in a recommendation response message sent by the resource server 6.

If the multimedia information is an advertisement, the value corresponding to the multimedia information may be an auction price set by the second user.

(3) The third-party platform receives the recommendation response message sent by each resource server, where the recommendation response message carries the value corresponding to the playback mode selected by the resource server.

Specifically, the third-party platform receives the recommendation response message sent by each resource server, and acquires, according to the recommendation response message sent by each resource server, the value corresponding to the playback mode selected by each resource server.

(4) The third-party platform acquires, according to the value corresponding to the playback mode selected by each server, the resource value corresponding to each playback mode.

Specifically, the third-party platform acquires all values corresponding to the first playback mode and all values corresponding to the second playback mode from the values corresponding to the playback modes selected by the resource servers; the third-party platform selects a maximum value from all the values corresponding to the first playback mode, and determines the maximum value as a resource value corresponding to the first playback mode; and the third-party platform selects a preset number of maximum values from all the values corresponding to the second playback mode, and calculates, according to the selected preset number of values, a resource value corresponding to the second playback mode.

For example, all the values corresponding to the first playback mode that are acquired by the third-party platform include 5, 6, and 8, and all the values corresponding to the second playback mode include 2, 3, 3, and 4. The third-party platform selects a maximum value 8 from all the values corresponding to the first playback mode, and determines the maximum value 8 as the resource value corresponding to the first playback mode. The second playback mode is to play by area, and the number of areas obtained through division may be any positive integer, for example, the number of the areas may be 3, 4, 5, 6, 7, or the like. An example in which the number of the areas is 3 is used for description. The third-party platform selects 3 maximum values 3, 3, and 4 from all the values corresponding to the second playback mode and including 2, 3, 3, and 4, and sums the selected 3 maximum values 3, 3, and 4 to calculate to obtain that the resource value corresponding to the second playback mode is 10.

If the multimedia information is an advertisement, the resource value corresponding to the first playback mode is a profit of the first playback mode, and the resource value corresponding to the second playback mode is a profit of the second playback mode.

For the second mode, step (A) to step (D) below are included:

(A) The third-party platform divides a first playback area into multiple second playback areas.

Specifically, the third-party platform acquires a corresponding division quantity from a correspondence between position information and a division quantity according to the position information of the terminal, and divides the first playback area according to the division quantity, to obtain the second playback areas, where the number of the second playback areas is the division quantity.

The third-party platform stores the correspondence between position information and a division quantity in advance.

For example, the third-party platform divides the first playback area into 3 second playback areas.

(B) The third-party platform sends a recommendation request message to each resource server in a set of resource servers, where the recommendation request message carries an identifier of the first playback area, an identifier of each second playback area, and the position information of the terminal.

Specifically, the third-party platform acquires a stored identifier of each resource server in the set of resource servers, and acquires the identifier of the first playback area, the identifier of each second playback area, and the position information of the terminal; and the third-party platform sends the recommendation request message to each resource server in the set of resource servers according to the identifier of each resource server, where the recommendation request message carries the identifier of the first playback area, the identifier of each second playback area, and the position information of the terminal.

The third-party platform stores the identifier of each resource server in advance, which may specifically be that:

the resource server sends a registration request message to the third-party platform, where the registration request message carries the identifier of the resource server; and the third-party platform receives the registration request message sent by the resource server, and stores the identifier of the resource server in the set of servers.

For example, it is assumed that the set of resource servers includes a resource server 1, a resource server 2, a resource server 3, a resource server 4, a resource server 5, and a resource server 6. The third-party platform sends the recommendation request message to the resource server 1, the resource server 2, the resource server 3, the resource server 4, the resource server 5, and the resource server 6, where the recommendation request message carries the identifier of the first playback area, the identifier of each second playback area, and the position information of the terminal.

(C) Each resource server receives the recommendation request message sent by the third-party platform, selects a playback area according to the recommendation request message, and acquires a value corresponding to the selected playback mode, and sends a recommendation response message to the third-party platform, where the recommendation response message carries the value corresponding to the playback area selected by the resource server.

Specifically, each resource server receives the recommendation request message sent by the third-party platform, acquires the identifier of the first playback area, the identifier of each second playback area, and the position information of the terminal according to the recommendation request message, and displays the identifier of the first playback area, the identifier of each second playback area, and the position information of the terminal to a second user; the second user selects a playback area according to the position information of the terminal, and inputs a value corresponding to the selected playback area to the resource server; and the resource server sends a recommendation response message to the third-party platform according to the value input by the second user and corresponding to the selected playback area, where the recommendation response message carries the value corresponding to the playback area selected by the resource server.

It should be noted that, each resource server may select one playback area, and each resource server may also select multiple playback areas. If the resource server selects one playback area, a value corresponding to the selected playback area is carried in a recommendation response message sent by the resource server; and if the resource server selects multiple playback areas, a value corresponding to each selected playback area is carried in the recommendation response message sent by the resource server.

For example, the resource server 1 is used as an example for detailed description. The resource server 1 receives the recommendation request message sent by the third-party platform, and displays the identifier of the first playback area, the identifier of each second playback area, and the position information of the terminal to a second user 1 corresponding to the resource server 1. A playback mode selected by the second user 1 according to the position information of the terminal is the first playback area, and a value 8 corresponding to the first playback area is input to the resource server 1. The resource server 1 sends a recommendation response message to the third-party platform, where the recommendation response message carries the identifier of the first playback area selected by the resource server 1 and the value 8 corresponding to the first playback area. The resource server 2, the resource server 3, the resource server 4, and the resource server 5 send recommendation response messages to the third-party platform according to the foregoing process. For example, the identifier of the first playback area and a value 6 corresponding to the first playback area are carried in a recommendation response message sent by the resource server 2; an identifier of a second playback area and a value 2 corresponding to the second playback area are carried in a recommendation response message sent by the resource server 3; the identifier of the first playback area, the value 8 corresponding to the first playback area, an identifier of a second playback area, and a value 3 corresponding to the second playback area are carried in a recommendation response message sent by the resource server 4; an identifier of a second playback area and a value 3 corresponding to the second playback area are carried in a recommendation response message sent by the resource server 5; and an identifier of a second playback area and a value 4 corresponding to the second playback area are carried in a recommendation response message sent by the resource server 6.

(D) The third-party platform receives the recommendation response message sent by each resource server, where the recommendation response message carries the value corresponding to the playback area selected by the resource server.

Specifically, the third-party platform receives the recommendation response message sent by each resource server, and acquires, according to the recommendation response message sent by each resource server, the value corresponding to the playback area selected by each resource server.

(E) The third-party platform acquires, according to the value corresponding to the playback area selected by each server, the resource value corresponding to each playback mode.

Specifically, the third-party platform acquires all values corresponding to the first playback area and all values corresponding to the second playback areas from the values corresponding to the playback areas selected by the resource servers; the third-party platform selects a maximum value from all the values corresponding to the first playback area, and determines the maximum value as a resource value corresponding to the first playback mode; and the third-party platform selects a preset number of maximum values from all the values corresponding to the second playback areas, and calculates, according to the selected preset number of values, a resource value corresponding to the second playback mode.

For example, all the values corresponding to the first playback area that are acquired by the third-party platform include 5, 6, and 8, and all the values corresponding to the second playback areas include 2, 3, 3, and 4; and the third-party platform selects a maximum value 8 from all the values corresponding to the first playback area and including 5, 6, and 8, and determines the maximum value 8 as the resource value corresponding to the first playback area, that is, determines the maximum value 8 as the resource value corresponding to the first playback mode. The second playback mode is to play by area, and the number of areas obtained through division may be any positive integer, for example, the number of the areas may be 3, 4, 5, 6, 7, or the like. An example in which the number of the areas is 3 is used for description. The third-party platform selects 3 maximum values 3, 3, and 4 from all the values corresponding to the second playback areas and including 2, 3, 3, and 4, and sums the selected 3 maximum values 3, 3, and 4 to calculate to obtain that the resource value corresponding to the second playback mode is 10.

Step 304: The third-party platform selects a playback mode with a maximum resource value.

Specifically, the third-party platform selects the playback mode with the maximum resource value according to the resource value corresponding to each playback mode.

For example, the resource value corresponding to the first playback mode is 8, and the resource value corresponding to the second playback mode is 10. The resource value 10 corresponding to the second playback mode is greater than the resource value 8 corresponding to the first playback mode, and the third-party platform selects the playback mode with the maximum resource value, that is, the second playback mode.

Step 305: The third-party platform acquires an identifier of the multimedia information according to the selected playback mode.

Specifically, if the selected playback mode is the first playback mode, a resource server corresponding to the maximum value is determined, and multimedia information that belongs to the resource server corresponding to the maximum value is acquired; and if the selected playback mode is the second playback mode, a resource server corresponding to each value in the preset number of maximum values is determined, and multimedia information that belongs to the resource server corresponding to each value is acquired.

It should be noted that, the identifier of the multimedia information may be further carried in the recommendation response message sent by each resource server, and a server acquires, according to the selected playback mode, the recommendation response message of the resource server corresponding to the selected playback mode, and acquires the identifier of the multimedia information according to the recommendation response message.

Step 306: The third-party platform sends the selected playback mode and the acquired identifier of the multimedia information to the terminal.

For example, if the playback mode selected by the third-party platform is the second playback mode, the acquired identifier of the multimedia information is multimedia information 1, and the third-party platform sends the second playback mode and the multimedia information 1 to the terminal.

Step 307: The terminal receives the selected playback mode and the acquired identifier of the multimedia information that are sent by the third-party platform, and plays the acquired multimedia information according to the selected playback mode.

Specifically, the terminal receives the selected playback mode and the acquired identifier of the multimedia information that are sent by the third-party platform, acquires the multimedia information according to the identifier of the multimedia information, and plays the acquired multimedia information according to the selected playback mode.

If the selected playback mode is the first playback mode, the acquired multimedia information is played in the first playback area, and if the selected playback mode is the second playback mode, the first playback area is divided into the multiple second playback areas according to the second playback mode, and the acquired multimedia information is separately played in the multiple second playback areas.

For example, if the second playback mode is to play in four areas, the terminal divides the first playback area into 4 second playback areas, and separately plays the acquired multimedia information in each second playback area.

In this embodiment of this application, a terminal has multiple playback modes for playing multimedia information, so that a third-party platform can send the multimedia information according to multiple modes; and the third-party platform selects a playback mode with a maximum resource value according to a resource value corresponding to each playback mode, acquires an identifier of the multimedia information according to the selected playback mode, and sends the selected playback mode and the acquired identifier of the multimedia information to the terminal, so that the third-party platform can acquire the resource value to the greatest extent.

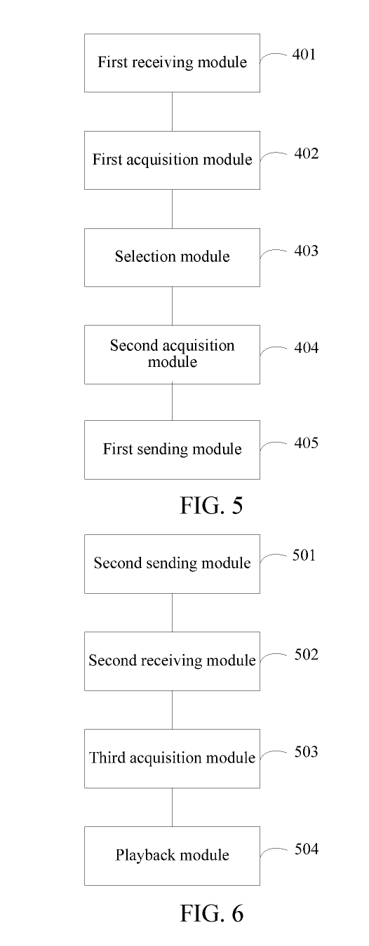

An embodiment of this application provides an apparatus for sending multimedia information. Referring to FIG. 5, the apparatus includes multiple modules. The following disclosed modules are program modules constituted by software instructions to be executed by processors for performing various operations as presented in methods according to various embodiments of present disclosure.

Specifically, in various embodiments, the apparatus includes:

a first receiving module 401 is configured to receive a multimedia playback request sent by a terminal;

a first acquisition module 402 is configured to acquire a resource value corresponding to each playback mode for playing multimedia information;

a selection module 403 is configured to select a playback mode with a maximum resource value;

a second acquisition module 404 is configured to acquire an identifier of the multimedia information according to the selected playback mode; and

a first sending module 405 is configured to send the selected playback mode and the acquired identifier of the multimedia information to the terminal.

Further, the first acquisition module 402 includes:

a first sending unit, configured to send a recommendation request message to each resource server in a set of resource servers, where the recommendation request message at least carries each playback mode for playing multimedia information;

a first receiving unit, configured to receive a recommendation response message sent by each resource server, where the recommendation response message carries a value corresponding to a playback mode selected by the resource server; and

a first acquisition unit, configured to acquire, according to the value corresponding to the playback mode selected by each resource server, the resource value corresponding to each playback mode.

Further, the playback mode includes a first playback mode and a second playback mode; and

the first acquisition unit includes:

a first acquisition subunit, configured to acquire all values corresponding to the first playback mode and all values corresponding to the second playback mode from the values corresponding to the playback modes selected by the resource servers;

a first determining subunit, configured to select a maximum value from all the values corresponding to the first playback mode, and determine the maximum value as a resource value corresponding to the first playback mode; and

a first calculation subunit, configured to select a preset number of maximum values from all the values corresponding to the second playback mode, and calculate, according to the selected preset number of values, a resource value corresponding to the second playback mode.

Further, the first acquisition module 402 includes:

a dividing unit, configured to divide a first playback area into multiple second playback areas;

a second sending unit, configured to send a recommendation request message to each resource server in a set of resource servers, where the recommendation request message at least carries an identifier of the first playback area and an identifier of each second playback area;

a second receiving unit, configured to receive a recommendation response message sent by each resource server, where the recommendation response message carries a value corresponding to a playback area selected by the resource server; and

a second acquisition unit, configured to acquire, according to the value corresponding to the playback area selected by each resource server, the resource value corresponding to each playback mode.

Further, the playback mode includes a first playback mode and a second playback mode; and

the second acquisition unit includes:

a second acquisition subunit, configured to acquire all values corresponding to the first playback area and all values corresponding to the second playback areas from the values corresponding to the playback areas selected by the resource servers;

a second determining subunit, configured to select a maximum value from all the values corresponding to the first playback area, and determine the maximum value as a resource value corresponding to the first playback mode; and

a second calculation subunit, configured to select a preset number of maximum values from all the values corresponding to the second playback areas, and calculate, according to the selected preset number of values, a resource value corresponding to the second playback mode.

Further, the second acquisition module 404 includes:

a third acquisition unit, configured to determine, if the selected playback mode is the first playback mode, a resource server corresponding to the maximum value, and acquire multimedia information that belongs to the resource server corresponding to the maximum value; and

a fourth acquisition unit, configured to determine, if the selected playback mode is the second playback mode, a resource server corresponding to each value in the preset number of maximum values, and acquire multimedia information that belongs to the resource server corresponding to each value.

In this embodiment of this application, a terminal has multiple playback modes for playing multimedia information, so that a third-party platform can send the multimedia information according to multiple modes; and the third-party platform selects a playback mode with a maximum resource value according to a resource value corresponding to each playback mode, acquires an identifier of the multimedia information according to the selected playback mode, and sends the selected playback mode and the acquired identifier of the multimedia information to the terminal, so that the third-party platform can acquire the resource value to the greatest extent.

An embodiment of this application provides an apparatus for playing multimedia information. Referring to FIG. 6, the apparatus includes:

a second sending module 501, configured to send a multimedia playback request to a third-party platform, so that the third-party platform selects a playback mode with a maximum resource value and acquires an identifier of multimedia information;

a second receiving module 502, configured to receive the selected playback mode and the acquired identifier of the multimedia information that are sent by the third-party platform;

a third acquisition module 503, configured to acquire the corresponding multimedia information according to the acquired identifier of the multimedia information; and

a playback module 504, configured to play the acquired multimedia information according to the selected playback mode.

Further, the playback module 504 is configured to play the acquired multimedia information in a first playback area if the selected playback mode is a first playback mode; and

the playback module 504 is further configured to divide, if the selected playback mode is a second playback mode, the first playback area into multiple second playback areas according to the second playback mode, and separately play the acquired multimedia information in the multiple second playback areas.

In this embodiment of this application, a terminal has multiple playback modes for playing multimedia information, so that a third-party platform can send the multimedia information according to multiple modes; and the third-party platform selects a playback mode with a maximum resource value according to a resource value corresponding to each playback mode, acquires an identifier of the multimedia information according to the selected playback mode, and sends the selected playback mode and the acquired identifier of the multimedia information to the terminal, so that the third-party platform can acquire the resource value to the greatest extent.

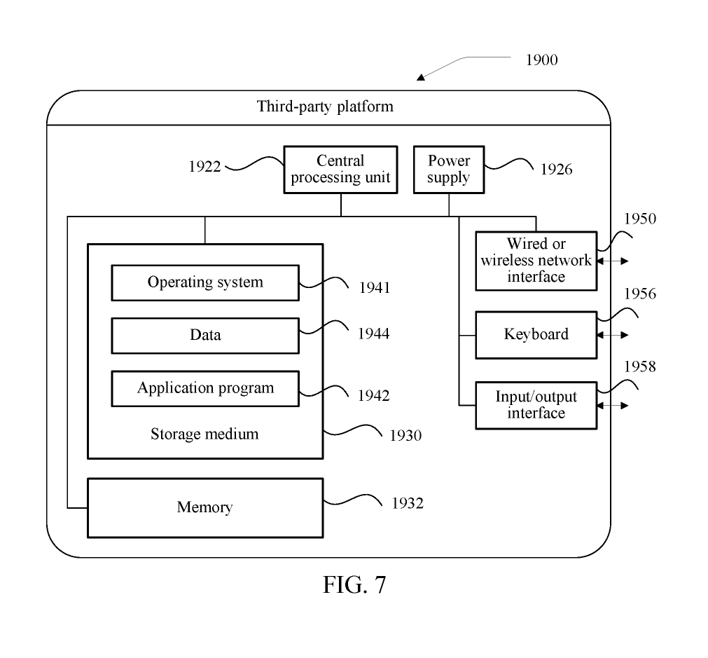

FIG. 7 is a schematic structural diagram of a third-party platform according to an embodiment of this application. The third-party platform 1900 may vary greatly due to different configurations or performance, and may include one or more central processing units (CPUs) 1922 (for example, one or more processors), a memory 1932, and one or more storage mediums 1930 (for example, one or more mass storage devices) for storing application programs 1942 or data 1944. The memory 1932 and the storage medium 1930 may be used for transient storage or persistent storage. A program stored in the storage medium 1930 may include one or more modules (not marked in the figure), and each module may include a series of instructions and operations for the third-party platform. Further, the CPU 1922 may be set to communicate with the storage medium 1930, and perform, on the third-party platform 1900, a series of instructions and operations in the storage medium 1930.

The third-party platform 1900 may further include one or more power supplies 1926, one or more wired or wireless network interfaces 1950, one or more input/output interfaces 1958, one or more keyboards 1956, and/or one or more operating systems 1941, for example, Windows Server™, Mac OS X™, Unix™, Linux™, FreeBSD™, or the like.

The third-party platform 1900 may include a memory and one or more programs, where the one or more programs are stored in the memory and configured to be executed by one or more processors. The one or more programs include instructions for performing the following operations:

receiving a multimedia playback request sent by a terminal;

acquiring a resource value corresponding to each playback mode for playing multimedia information;

selecting a playback mode with a maximum resource value; and

acquiring an identifier of the multimedia information according to the selected playback mode, and sending the selected playback mode and the acquired identifier of the multimedia information to the terminal.

Preferably, the acquiring a resource value corresponding to each playback mode for playing multimedia information includes:
sending a recommendation request message to each resource server in a set of resource servers, where the recommendation request message at least carries each playback mode for playing multimedia information;

receiving a recommendation response message sent by each resource server, where the recommendation response message carries a value corresponding to a playback mode selected by the resource server; and

acquiring, according to the value corresponding to the playback mode selected by each resource server, the resource value corresponding to each playback mode.

Preferably, the playback mode includes a first playback mode and a second playback mode; and

the acquiring, according to the value corresponding to the playback mode selected by each resource server, the resource value corresponding to each playback mode includes:

acquiring all values corresponding to the first playback mode and all values corresponding to the second playback mode from the values corresponding to the playback modes selected by the resource servers;

selecting a maximum value from all the values corresponding to the first playback mode, and determining the maximum value as a resource value corresponding to the first playback mode; and

selecting a preset number of maximum values from all the values corresponding to the second playback mode, and calculating, according to the selected preset number of values, a resource value corresponding to the second playback mode.

Preferably, the acquiring a resource value corresponding to each playback mode for playing multimedia information includes:

dividing a first playback area into multiple second playback areas;

sending a recommendation request message to each resource server in a set of resource servers, where the recommendation request message at least carries an identifier of the first playback area and an identifier of each second playback area;

receiving a recommendation response message sent by each resource server, where the recommendation response message carries a value corresponding to a playback area selected by the resource server; and

acquiring, according to the value corresponding to the playback area selected by each resource server, the resource value corresponding to each playback mode.

Preferably, the playback mode includes a first playback mode and a second playback mode; and

the acquiring, according to the value corresponding to the playback area selected by each resource server, the resource value corresponding to each playback mode includes:

acquiring all values corresponding to the first playback area and all values corresponding to the second playback areas from the values corresponding to the playback areas selected by the resource servers;

selecting a maximum value from all the values corresponding to the first playback area, and determining the maximum value as a resource value corresponding to the first playback mode; and

selecting a preset number of maximum values from all the values corresponding to the second playback areas, and calculating, according to the selected preset number of values, a resource value corresponding to the second playback mode.

Preferably, the acquiring an identifier of the multimedia information according to the selected playback mode includes:

determining, if the selected playback mode is the first playback mode, a resource server corresponding to the maximum value, and acquiring multimedia information that belongs to the resource server corresponding to the maximum value; and

determining, if the selected playback mode is the second playback mode, a resource server corresponding to each value in the preset number of maximum values, and acquiring multimedia information that belongs to the resource server corresponding to each value.

In this embodiment of this application, a terminal has multiple playback modes for playing multimedia information, so that a third-party platform can send the multimedia information according to multiple modes; and the third-party platform selects a playback mode with a maximum resource value according to a resource value corresponding to each playback mode, acquires an identifier of the multimedia information according to the selected playback mode, and sends the selected playback mode and the acquired identifier of the multimedia information to the terminal, so that the third-party platform can acquire the resource value to the greatest extent.

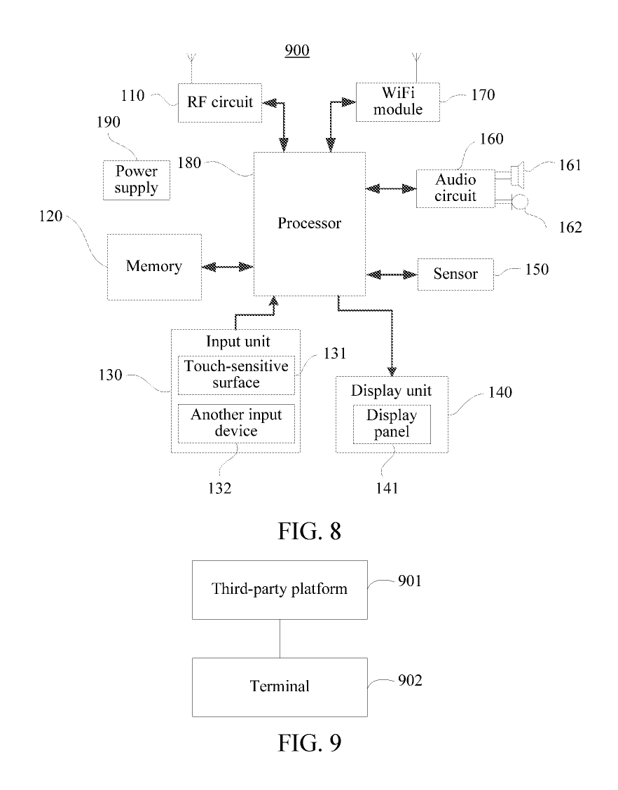

Referring to FIG. 8, FIG. 8 shows a schematic structural diagram of a terminal having a touch-sensitive surface and related in an embodiment of this application. The terminal may be configured to implement the method provided by the foregoing embodiment. Specifically:

The terminal 900 may include components such as a radio frequency (RF) circuit 110, a memory 120 including one or more computer readable storage mediums, an input unit 130, a display unit 140, a sensor 150, an audio circuit 160, a wireless fidelity (WiFi) module 170, a processor 180 including one or more processing cores, and a power supply 190. A person skilled in the art may understand that the structure of the terminal shown in FIG. 8 does not constitute a limitation to the terminal, and the terminal may include more components or fewer components than those shown in the figure, or some components may be combined, or a different component deployment may be used.

The RF circuit 110 may be may be configured to receive and send signals during an information receiving and sending process or a call process. Particularly, the RF circuit 110 receives downlink information from a base station, then delivers the downlink information to one or more processors 180 for processing, and sends related uplink data to the base station. Generally, the RF circuit 110 includes, but is not limited to, an antenna, at least one amplifier, a tuner, one or more oscillators, a subscriber identity module (SIM) card, a transceiver, a coupler, a low noise amplifier (LNA), and a duplexer. In addition, the RF circuit 110 may also communicate with a network and another device by wireless communication. The wireless communication may use any communications standard or protocol, which includes, but is not limited to, Global System for Mobile Communications (GSM), General Packet Radio Service (GPRS), Code Division Multiple Access (CDMA), Wideband Code Division Multiple Access (WCDMA), Long Term Evolution (LTE), e-mail, Short Messaging Service (SMS), and the like.

The memory 120 may be configured to store a software program and module. The processor 180 runs the software program and module stored in the memory 120, to implement various functional applications and data processing. The memory 120 may mainly include a program storage area and a data storage area. The program storage area may store an operating system, an application program required by at least one function (such as a sound playback function and an image display function), and the like. The data storage area may store data (such as audio data and an address book) created according to use of the terminal 900, and the like. In addition, the memory 120 may include a high speed random access memory, and may also include a non-volatile memory such as at least one magnetic disk storage device, a flash memory, or another volatile solid-state storage device. Accordingly, the memory 120 may further include a memory controller, so that the processor 180 and the input unit 130 access the memory 120.

The input unit 130 may be configured to receive input digit or character information, and generate a keyboard, mouse, joystick, optical, or track ball signal input related to the user setting and the function control. Specifically, the input unit 130 may include a touch-sensitive surface 131 and another input device 132. The touch-sensitive surface 131, which may also be referred to as a touch screen or a touch panel, may collect a touch operation of a user on or near the touch-sensitive surface (such as an operation of a user on the touch-sensitive surface 131 or near the touch-sensitive surface 131 by using any suitable object or accessory, such as a finger or a stylus), and drive a corresponding connection apparatus according to a preset program. Optionally, the touch-sensitive surface 131 may include two parts: a touch detection apparatus and a touch controller. The touch detection apparatus detects a touch position of the user, detects a signal generated by the touch operation, and transfers the signal to the touch controller. The touch controller receives the touch information from the touch detection apparatus, converts the touch information into touch point coordinates, and sends the touch point coordinates to the processor 180. Moreover, the touch controller can receive and execute a command sent from the processor 180. In addition, the touch-sensitive surface 131 may be a resistive, capacitive, infrared, or surface sound wave type touch-sensitive surface. In addition to the touch-sensitive surface 131, the input unit 130 may further include the another input device 132. Specifically, the another input device 132 may include, but is not limited to, one or more of a physical keyboard, a functional key (such as a volume control button or a switch key), a track ball, a mouse, and a joystick.

The display unit 140 may be configured to display information input by the user or information provided for the user, and various graphical user interfaces of the terminal 900. The graphical user interfaces may be formed by a graph, a text, an icon, a video, or any combination thereof. The display unit 140 may include a display panel 141. Optionally, the display panel 141 may be configured by using a liquid crystal display (LCD), an organic light-emitting diode (OLED), or the like. Further, the touch-sensitive surface 131 may cover the display panel 141. After detecting a touch operation on or near the touch-sensitive surface 131, the touch-sensitive surface 131 transfers the touch operation to the processor 180, so as to determine the type of the touch event. Then, the processor 180 provides a corresponding visual output on the display panel 141 according to the type of the touch event. Although, in FIG. 8, the touch-sensitive surface 131 and the display panel 141 are used as two separate components to implement input and output functions, in some embodiments, the touch-sensitive surface 131 and the display panel 141 may be integrated to implement the input function and output functions.

The terminal 900 may further include at least one sensor 150, such as an optical sensor, a motion sensor, and other sensors. Specifically, the optical sensor may include an ambient light sensor and a proximity sensor. The ambient light sensor can adjust luminance of the display panel 141 according to brightness of the ambient light. The proximity sensor may switch off the display panel 141 and/or backlight when the terminal 900 is moved to the ear. As one type of motion sensor, a gravity acceleration sensor can detect magnitude of accelerations in various directions (generally on three axes), may detect magnitude and a direction of the gravity when static, and may be applied to an application that recognizes the attitude of the mobile phone (for example, switching between landscape orientation and portrait orientation, a related game, and magnetometer attitude calibration), a function related to vibration recognition (such as a pedometer and a knock), and the like. Other sensors, such as a gyroscope, a barometer, a hygrometer, a thermometer, and an infrared sensor, which may be configured in the terminal 900, are not further described herein.

The audio circuit 160, a loudspeaker 161, and a microphone 162 may provide an audio interface between the user and the terminal 900. The audio circuit 160 may convert received audio data into an electric signal and transmit the electric signal to the loudspeaker 161. The loudspeaker 161 converts the electric signal into a sound signal for output. On the other hand, the microphone 162 converts a collected sound signal into an electric signal. The audio circuit 160 receives the electric signal and converts the electric signal into audio data, and outputs the audio data to the processor 180 for processing. Then, the processor 180 sends the audio data to, for example, another terminal by using the RF circuit 110, or outputs the audio data to the memory 120 for further processing. The audio circuit 160 may further include an earplug jack, so as to provide communication between a peripheral earphone and the terminal 900.

WiFi is a short distance wireless transmission technology. The terminal 900 may help, by using the WiFi module 170, the user to receive and send e-mails, browse a webpage, access streaming media, and so on, which provides wireless broadband Internet access for the user. Although FIG. 8 shows the WiFi module 170, it may be understood that the WiFi module 170 is not a necessary component of the terminal 900, and when required, the WiFi module 170 may be omitted as long as the scope of the essence of this application is not changed.

The processor 180 is the control center of the terminal 900, and is connected to various parts of the terminal by using various interfaces and lines. By running or executing the software program and/or module stored in the memory 120, and invoking data stored in the memory 120, the processor 180 performs various functions and data processing of the terminal 900, thereby performing overall monitoring on the terminal. Optionally, the processor 180 may include the one or more processing cores. Preferably, the processor 180 may integrate an application processor and a modem. The application processor mainly processes an operating system, a user interface, an application program, and the like. The modem mainly processes wireless communication. It may be understood that the foregoing modem may not be integrated into the processor 180.

The terminal 900 further includes the power supply 190 (such as a battery) for supplying power to the components. Preferably, the power supply may be logically connected to the processor 180 by using a power management system, thereby implementing functions, such as charging, discharging, and power consumption management, by using the power management system. The power supply 190 may further include one or more of a direct current or alternating current power supply, a re-charging system, a power failure detection circuit, a power supply converter or inverter, a power supply state indicator, and any other components.

Although not shown in the figure, the terminal 900 may further include a camera, a Bluetooth module, and the like, which are not described herein again. Specifically, in this embodiment, the display unit of the terminal 900 is a touch screen display, and the terminal 900 further includes a memory and one or more programs. The one or more programs are stored in the memory and configured to be executed by the one or more processors. The one or more programs include instructions for performing the following operations:

sending a multimedia playback request to a third-party platform, so that the third-party platform selects a playback mode with a maximum resource value and acquires an identifier of multimedia information;

receiving the selected playback mode and the acquired identifier of the multimedia information that are sent by the third-party platform;

acquiring the corresponding multimedia information according to the acquired identifier of the multimedia information; and

playing the acquired multimedia information according to the selected playback mode.

Preferably, the playing the acquired multimedia information according to the selected playback mode includes:

playing the acquired multimedia information in a first playback area if the selected playback mode is a first playback mode; and

dividing, if the selected playback mode is a second playback mode, the first playback area into multiple second playback areas according to the second playback mode, and separately playing the acquired multimedia information in the multiple second playback areas.

In this embodiment of this application, a terminal has multiple playback modes for playing multimedia information, so that a third-party platform can send the multimedia information according to multiple modes; and the third-party platform selects a playback mode with a maximum resource value according to a resource value corresponding to each playback mode, acquires an identifier of the multimedia information according to the selected playback mode, and sends the selected playback mode and the acquired identifier of the multimedia information to the terminal, so that the third-party platform can acquire the resource value to the greatest extent.

An embodiment of this application provides a schematic structural diagram of a system for sending and playing multimedia information. Referring to FIG. 9, the system includes: a third-party platform 901 and a terminal 902.

The third-party platform 901 is configured to receive a multimedia playback request sent by a terminal; acquire a resource value corresponding to each playback mode for playing multimedia information; select a playback mode with a maximum resource value; and acquire an identifier of the multimedia information according to the selected playback mode, and send the selected playback mode and the acquired identifier of the multimedia information to the terminal.

The terminal 902 is configured to send the multimedia playback request to the third-party platform; receive the selected playback mode and the acquired identifier of the multimedia information that are sent by the third-party platform; acquire the corresponding multimedia information according to the acquired identifier of the multimedia information; and play the acquired multimedia information according to the selected playback mode.

In this embodiment of this application, a terminal has multiple playback modes for playing multimedia information, so that a third-party platform can send the multimedia information according to multiple modes; and the third-party platform selects a playback mode with a maximum resource value according to a resource value corresponding to each playback mode, acquires an identifier of the multimedia information according to the selected playback mode, and sends the selected playback mode and the acquired identifier of the multimedia information to the terminal, so that the third-party platform can acquire the resource value to the greatest extent.

It should be noted that, the division of the above functional modules is only described for exemplary purposes when the apparatus for sending and playing multimedia information provided by the foregoing embodiment sends and plays the multimedia information. In actual applications, the functions may be accomplished by different functional modules according to requirements, that is, the internal structure of the apparatus is divided into different functional modules to complete all or some of the functions described above. In addition, the apparatus for sending and playing multimedia information provided by the foregoing embodiment is based on the same concept as the method for sending and playing multimedia information in the foregoing embodiments. For the specific implementation process, refer to the method embodiments, and details are not described herein again.

A person of ordinary skill in the art may understand that all or some of the steps of the foregoing embodiments may be implemented by using hardware, or may be implemented by a program instructing relevant hardware. The program may be stored in a computer readable storage medium. The storage medium may be a read-only memory, a magnetic disk, an optical disc, or the like.

The foregoing descriptions are merely preferred embodiments of this application, but are not intended to limit this application. Any modification, equivalent replacement, or improvement made within the spirit and principle of this application shall fall within the protection scope of this application.

What is claimed is:

1. A method for sending multimedia information, comprising:
receiving a multimedia playback request sent by a terminal;
acquiring a resource value corresponding to each playback mode for playing multimedia information;
selecting a playback mode with a maximum resource value; and
acquiring an identifier of the multimedia information according to the selected playback mode, and sending the selected playback mode and the acquired identifier of the multimedia information to the terminal.

2. The method according to claim 1, wherein the acquiring a resource value corresponding to each playback mode for playing multimedia information comprises:
sending a recommendation request message to each resource server in a set of resource servers, wherein the recommendation request message at least carries each playback mode for playing multimedia information;
receiving a recommendation response message sent by each resource server, wherein the recommendation response message carries a value corresponding to a playback mode selected by the resource server; and
acquiring, according to the value corresponding to the playback mode selected by each resource server, the resource value corresponding to each playback mode.

3. The method according to claim 2, wherein the playback mode comprises a first playback mode and a second playback mode; and
the acquiring, according to the value corresponding to the playback mode selected by each resource server, the resource value corresponding to each playback mode comprises:
acquiring all values corresponding to the first playback mode and all values corresponding to the second playback mode from the values corresponding to the playback modes selected by the resource servers;
selecting a maximum value from all the values corresponding to the first playback mode, and determining the maximum value as a resource value corresponding to the first playback mode; and
selecting a preset number of maximum values from all the values corresponding to the second playback mode, and calculating, according to the selected preset number of values, a resource value corresponding to the second playback mode.

4. The method according to claim 1, wherein the acquiring a resource value corresponding to each playback mode for playing multimedia information comprises:
dividing a first playback area into multiple second playback areas;
sending a recommendation request message to each resource server in a set of resource servers, wherein the recommendation request message at least carries an identifier of the first playback area and an identifier of each second playback area;
receiving a recommendation response message sent by each resource server, wherein the recommendation response message carries a value corresponding to a playback area selected by the resource server; and
acquiring, according to the value corresponding to the playback area selected by each resource server, the resource value corresponding to each playback mode.

5. The method according to claim 4, wherein the playback mode comprises a first playback mode and a second playback mode; and
the acquiring, according to the value corresponding to the playback area selected by each resource server, the resource value corresponding to each playback mode comprises:
acquiring all values corresponding to the first playback area and all values corresponding to the second playback areas from the values corresponding to the playback areas selected by the resource servers;
selecting a maximum value from all the values corresponding to the first playback area, and determining the maximum value as a resource value corresponding to the first playback mode; and
selecting a preset number of maximum values from all the values corresponding to the second playback areas, and calculating, according to the selected preset number of values, a resource value corresponding to the second playback mode.

6. The method according to claim 3, wherein the acquiring an identifier of the multimedia information according to the selected playback mode comprises:
determining, if the selected playback mode is the first playback mode, a resource server corresponding to the maximum value, and acquiring multimedia information that belongs to the resource server corresponding to the maximum value; and
determining, if the selected playback mode is the second playback mode, a resource server corresponding to each value in the preset number of maximum values, and acquiring multimedia information that belongs to the resource server corresponding to each value.

7. A method for playing multimedia information, comprising:
sending a multimedia playback request to a third-party platform, so that the third-party platform selects a playback mode with a maximum resource value and acquires an identifier of multimedia information;
receiving the selected playback mode and the acquired identifier of the multimedia information that are sent by the third-party platform;
acquiring the corresponding multimedia information according to the acquired identifier of the multimedia information; and
playing the acquired multimedia information according to the selected playback mode.

8. The method according to claim 7, wherein the playing the acquired multimedia information according to the selected playback mode comprises:
playing the acquired multimedia information in a first playback area if the selected playback mode is a first playback mode; and
dividing, if the selected playback mode is a second playback mode, the first playback area into multiple second playback areas according to the second playback mode, and separately playing the acquired multimedia information in the multiple second playback areas.

9. An apparatus for sending multimedia information, comprising:
a first receiving module, comprising software instructions for receiving a multimedia playback request sent by a terminal;
a first acquisition module, comprising software instructions for acquiring a resource value corresponding to each playback mode for playing multimedia information;
a selection module, comprising software instructions for selecting a playback mode with a maximum resource value;
a second acquisition module, comprising software instructions for acquiring an identifier of the multimedia information according to the selected playback mode; and
a first sending module, comprising software instructions for sending the selected playback mode and the acquired identifier of the multimedia information to the terminal.

10. The apparatus according to claim 9, wherein the first acquisition module comprises:
a first sending unit, configured to send a recommendation request message to each resource server in a set of resource servers, wherein the recommendation request message at least carries each playback mode for playing multimedia information;
a first receiving unit, configured to receive a recommendation response message sent by each resource server, wherein the recommendation response message carries a value corresponding to a playback mode selected by the resource server; and
a first acquisition unit, configured to acquire, according to the value corresponding to the playback mode selected by each resource server, the resource value corresponding to each playback mode.

11. The apparatus according to claim 10, wherein the playback mode comprises a first playback mode and a second playback mode; and
the first acquisition unit comprises:
a first acquisition subunit, configured to acquire all values corresponding to the first playback mode and all values corresponding to the second playback mode from the values corresponding to the playback modes selected by the resource servers;
a first determining subunit, configured to select a maximum value from all the values corresponding to the first playback mode, and determine the maximum value as a resource value corresponding to the first playback mode; and
a first calculation subunit, configured to select a preset number of maximum values from all the values corresponding to the second playback mode, and calculate, according to the selected preset number of values, a resource value corresponding to the second playback mode.

12. The apparatus according to claim 9, wherein the first acquisition module comprises:
a dividing unit, configured to divide a first playback area into multiple second playback areas;
a second sending unit, configured to send a recommendation request message to each resource server in a set of resource servers, wherein the recommendation request message at least carries an identifier of the first playback area and an identifier of each second playback area;
a second receiving unit, configured to receive a recommendation response message sent by each resource server, wherein the recommendation response message carries a value corresponding to a playback area selected by the resource server; and
a second acquisition unit, configured to acquire, according to the value corresponding to the playback area selected by each resource server, the resource value corresponding to each playback mode.

13. The apparatus according to claim 12, wherein the playback mode comprises a first playback mode and a second playback mode; and
the second acquisition unit comprises:
a second acquisition subunit, configured to acquire all values corresponding to the first playback area and all values corresponding to the second playback areas from the values corresponding to the playback areas selected by the resource servers;
a second determining subunit, configured to select a maximum value from all the values corresponding to the first playback area, and determine the maximum value as a resource value corresponding to the first playback mode; and
a second calculation subunit, configured to select a preset number of maximum values from all the values corresponding to the second playback areas, and calculate, according to the selected preset number of values, a resource value corresponding to the second playback mode.

14. The apparatus according to claim 11, wherein the second acquisition module comprises:
a third acquisition unit, configured to determine, if the selected playback mode is the first playback mode, a resource server corresponding to the maximum value, and acquire multimedia information that belongs to the resource server corresponding to the maximum value; and
a fourth acquisition unit, configured to determine, if the selected playback mode is the second playback mode, a resource server corresponding to each value in the preset number of maximum values, and acquire multimedia information that belongs to the resource server corresponding to each value.
